(19) United States
(12) Patent Application Publication
(10) Pub. No.: US 2021/0382350 A1
(43) Pub. Date: Dec. 9, 2021

(54) REFLECTIVE FILTER, MANUFACTURING METHOD THEREOF, AND REFLECTIVE DISPLAY DEVICE

(71) Applicant: TCL CHINA STAR OPTOELECTRONICS TECHNOLOGY CO., LTD., SHENZHEN, GUANGDONG (CN)

(72) Inventor: Mei CHEN, Shenzhen, Guangdong (CN)

(21) Appl. No.: 16/969,642

(22) PCT Filed: Jul. 10, 2020
(86) PCT No.: PCT/CN2020/101237

§ 371 Date: Aug. 13, 2020

(30) Foreign Application Priority Data
Jun. 5, 2020 (CN) 202010504161X

(51) Int. Cl. G02F 1/1335; G02B 5/26; G02F 1/137; G02F 1/1343

(52) U.S. Cl. CPC G02F 1/133553; G02F 1/134309; G02F 1/13718; G02B 5/26

(57) ABSTRACT

A reflective filter includes a first substrate provided with a first electrode, a second substrate provided with a second electrode, and a liquid crystal layer filled with a liquid crystal composition including cholesteric liquid crystals, wherein the reflective filter includes at least two reflective areas that reflect light of different colors. By applying an external electric field to align the liquid crystal molecules, ultraviolet light is used to induce a chiral compound to subject to chiral inversion, such that the division control of the reflective areas is realized in a same kind of a liquid crystal material matrix.

### BACKGROUND OF INVENTION

The present application claims priority to Chinese patent application no. 202010504161.X submitted to Chinese Patent Office on Jun. 5, 2020, entitled “reflective filter, manufacturing method thereof, and reflective display device”, the entire contents of which are incorporated herein by reference.

### FIELD OF INVENTION

The present application relates to a field of display technology, in particular to a reflective filter, a method of manufacturing the same, and a reflective display device.

### DESCRIPTION OF PRIOR ART

Color filters are widely used in the display field. Traditional color filters are mostly absorption filters, whose light loss rate can reach more than 60%, greatly limiting the light energy utilization rate of liquid crystal displays. In addition, the traditional color filters are generally prepared by dispersing red, green, and blue dyes in photoresists, and then forming the red color resists, the green color resists, and the blue color resists on the substrate through three of yellow light processes. The manufacturing process is complicated and cumbersome.

In summary, the existing absorption color filter technology needs to be improved.

### SUMMARY OF INVENTION

Embodiments of the present application provide a reflective filter, a manufacturing method thereof, and a reflective display device, to solve the technical problems of the existing absorption color filter, which has a high light loss rate and requires a complicated and complicated manufacturing process.

In order to solve the above problem, the technical solutions provided by the present invention are as follows:

An embodiment of the present application provides a reflective filter, including: a first substrate and a second substrate oppositely disposed, wherein a side of the first substrate facing the second substrate is provided with a first electrode, and a side of the second substrate facing the first substrate is provided with a second electrode; and a liquid crystal layer interposed between the first substrate and the second substrate, wherein the liquid crystal layer is filled with a liquid crystal composition including cholesteric liquid crystals, wherein the reflective filter includes at least two reflective areas configured to reflect light of different colors.

In at least one embodiment of the present application, the reflective filter further includes a first reflective area, a second reflective area, and a third reflective area configured to respectively reflect light of three different colors.

In at least one embodiment of the present application, a helical pitch of the cholesteric liquid crystals in the first reflective area, a helical pitch of the cholesteric liquid crystals in the second reflective area, and a helical pitch of the cholesteric liquid crystals in the third reflective area increase in sequence.

In at least one embodiment of the present application, the first reflective area is configured to reflect blue light, the second reflective area is configured to reflect green light, and the third reflective area is configured to reflect red light.

In at least one embodiment of the present application, the liquid crystal composition includes a rigid polymer network structure.

In at least one embodiment of the present application, the liquid crystal composition includes nematic liquid crystals, a chiral compound, a polymerizable monomer, and a thermal initiator.

In at least one embodiment of the present application, each of the first electrode and the second electrode is disposed over an entire surface.

Another embodiment of the present application also provides a method of manufacturing the reflective filter according to any one of the foregoing embodiments, including:

S10, filling a liquid crystal composition between the first substrate and the second substrate to form a liquid crystal layer, wherein the liquid crystal composition includes cholesteric liquid crystals having an initial reflection band of light;

S20, applying a voltage to the first electrode and the second electrode such that the cholesteric liquid crystals are in a planar texture state;

S30, under a power-on state, irradiating the liquid crystal layer by an ultraviolet light of a first time using a first photomask, such that a helical pitch of the cholesteric liquid crystals in an area irradiated by the ultraviolet light of the first time is greater than a helical pitch of the cholesteric liquid crystals in an unirradiated area;

S40, heating the liquid crystal layer under a power-on state and irradiation by ultraviolet light, such that the liquid crystal composition forms a rigid polymer network structure.

In at least one embodiment of the present application, before the step S40, the method further including:

under a power-on state, irradiating the liquid crystal layer by ultraviolet light of a second time using a second photomask, such that a helical pitch of the cholesteric liquid crystals in an area irradiated by ultraviolet light of the second time is greater than the helical pitch of the cholesteric liquid crystals in the area irradiated by ultraviolet light of the first time.

In at least one embodiment of the present application, the light in the initial reflection band corresponds to blue light, the cholesteric liquid crystals in the area irradiated by the ultraviolet light of the first time reflects green light, and the cholesteric liquid crystals in the area irradiated by the ultraviolet light of the second time reflects red light.

In at least one embodiment of the present application, the liquid crystal composition includes nematic liquid crystals, a chiral compound, a polymerizable monomer, and a thermal initiator.

Still another embodiment of the present application also provides a reflective display device, including a display panel and a reflective filter provided on a side away from a light-exiting surface of the display panel, wherein the reflective filter includes: a first substrate and a second substrate oppositely disposed, wherein a side of the first substrate facing the second substrate is provided with a first electrode, and a side of the second substrate facing the first substrate is provided with a second electrode; and a liquid crystal layer interposed between the first substrate and the second substrate, wherein the liquid crystal layer is filled with a liquid crystal composition including cholesteric liquid crystals, wherein the reflective filter includes at least two reflective areas configured to reflect light of different colors.

In at least one embodiment of the present application, the reflective filter includes a first reflective area, a second reflective area, and a third reflective area configured to respectively reflect light of three different colors.

In at least one embodiment of the present application, a helical pitch of the cholesteric liquid crystals in the first reflective area, a helical pitch of the cholesteric liquid crystals in the second reflective area, and a helical pitch of the cholesteric liquid crystals in the third reflective area increase in sequence.

In at least one embodiment of the present application, the first reflective area is configured to reflect blue light, the second reflective area is configured to reflect green light, and the third reflective area is configured to reflect red light.

In at least one embodiment of the present application, the liquid crystal composition includes a rigid polymer network structure.

In at least one embodiment of the present application, the liquid crystal composition includes nematic liquid crystals, a chiral compound, a polymerizable monomer, and a thermal initiator.

In at least one embodiment of the present application, each of the first electrode and the second electrode is disposed over an entire surface.

On the one hand, by applying an external electric field to align the liquid crystal molecules, no additional liquid crystal alignment treatment is required, which makes the process simple and cost-effective; on the other hand, by using ultraviolet light to induce a chiral compound to subject to chiral inversion so as to realize partition control of the reflective are in the same liquid crystal material matrix, there is no need to pattern electrodes, the common electrode may be disposed over an entire surface, and no barrier wall is required, thereby further simplifying the process. In addition, the reflective color filter can be formed as a flexible film material due to addition of polymer materials, which is beneficial to realize a large-area roll-to-roll process, thereby reducing the production and transportation costs of the filter.

### BRIEF DESCRIPTION OF DRAWINGS

FIG. 1 is a schematic structural diagram of a reflective filter provided by an embodiment of the present application.

FIG. 2 is a flowchart of steps of a method of manufacturing a reflective filter provided by an embodiment of the present application.

FIG. 3 is a schematic structural diagram of a liquid crystal layer in a power-off state provided by an embodiment of the present application.

FIG. 4 is a schematic structural diagram of a liquid crystal layer under a power-on state provided by an embodiment of the present application.

FIG. 5 is a schematic structural diagram of a liquid crystal layer under irradiation by ultraviolet light provided by an embodiment of the present application.

FIG. 6 is a schematic structural diagram of a liquid crystal layer irradiated with secondary ultraviolet light provided by an embodiment of the present application.

FIG. 7 is a schematic structural diagram of a display device provided by an embodiment of the present application.

### DETAILED DESCRIPTION OF PREFERRED EMBODIMENTS

The present application provides a reflective filter, a manufacturing method thereof, and a reflective display device. In order to make the purpose, technical solutions, and effects of the present application clearer and more definite, the present application will be further described in detail below with reference to the accompanying drawings and examples. It should be understood that the specific embodiments described herein are only used to explain the present application, and are not used to limit the present application.

A reflective filter provided by the present application includes a first substrate and a second substrate that are oppositely arranged, and a liquid crystal layer, wherein a side of the first substrate facing the second substrate is provided with a first electrode, a side of the second substrate facing the first substrate is provided with a second electrode, and the liquid crystal layer is filled with a liquid crystal composition.

The liquid crystal composition includes cholesteric liquid crystals (Cholesteric liquid crystals, CLC) having characteristic of selectively reflecting light, and thereby the cholesteric liquid crystals can be used to prepare a reflective filter using its unique characteristics. Plane-aligned cholesteric liquid crystals can reflect circularly polarized light having an optical rotation direction the same as their own spiral axis, and transmit other light. Since a filter system composed of the above reflective filter does not absorb light, it can be used to produce a color filter or a polarizer with high light energy utilization efficiency. A wavelength of selectively reflected light of the cholesteric liquid crystals is determined by a helical pitch and birefringence of the cholesteric liquid crystals, and the wavelength, pitch, and birefringence satisfy the following relationship: λ=n*p, where n is the refractive index and p is the helical pitch. The reflection wavelength can be effectively controlled by changing the helical pitch p of the cholesteric liquid crystals.

Since the traditional filter is an absorption filter, the light loss rate is high, and three yellow light processes are required to form red, green, and blue color resists, such that the manufacturing process is complicated. The reflective filter provided in an embodiment of the present application may include at least two reflective areas configured to reflect light of different colors. By controlling the helical pitch of the cholesteric liquid crystals in the corresponding area, the different reflective areas reflect different colors, thereby achieving the effect of light filtering.

The cholesteric liquid crystals may be cholesteric compounds, or a mixture of nematic liquid crystals and a chiral compound, wherein the helical pitch of the cholesteric liquid crystals is determined by the content of the chiral compound in the liquid crystal composition and its spiral twisting force. When the types of the nematic liquid crystals and the chiral compound are fixed, the helical pitch of the cholesteric liquid crystals can be controlled by controlling the content of the chiral compound.

The chiral-inversed chiral compound can be added to the nematic liquid crystals, so that the content of the overall chiral compound in the liquid crystal layer system can be controlled by controlling the inversion amount of the chiral compound, that is, by controlling the helical pitch of the cholesteric liquid crystals.

Further, the inversion amount of the chiral compound can be controlled by controlling the period that the ultraviolet light irradiates the cholesteric liquid crystals, thereby controlling the helical pitch of the cholesteric liquid crystals.

The reflective filter includes at least two reflective areas that reflect light of different colors. The helical pitches of the cholesteric liquid crystals in the reflective areas that reflect light of different colors is different. By using ultraviolet light to induce the chiral compound to subject to chiral inversion, the content of chiral compounds in an area irradiated by the ultraviolet light decreases, that is, the helical pitch increases.

In one embodiment, the liquid crystal composition may include nematic liquid crystals, a chiral compound, a polymerizable monomer, and a thermal initiator.

Specifically, the liquid crystal composition may include negative nematic liquid crystals, an ultraviolet-induced chiral-inversed compound, a liquid crystal thermopolymerizable monomer, and a thermal initiator. Relative to the overall weight of the composition, amounts in weight percentage of the negative nematic liquid crystals, the UV-induced chiral-inversed compounds, the liquid crystal thermopolymerizable monomers, and the thermal initiators is 60-98 wt % negative nematic liquid crystal, 1-30 wt % liquid crystal thermally polymerizable monomer, 0.05-10 wt % ultraviolet-induced isomerized chiral compound, and 0.05-2 wt % thermal initiator.

The ultraviolet-induced isomerized chiral compound has a first rotation direction (being left-handed or right-handed) under visible light, which can be inversed to have a second rotation direction (right-handed or left-handed) after being irradiated with ultraviolet light, that is, under ultraviolet light, the structure of the chiral compound will undergo isomerization and the chiral direction will be inversed correspondingly. Therefore, the content of the chiral compound ultimately present in the liquid crystal layer in different areas can be controlled by controlling the amount of chiral rotation amount of the chiral compound.

The ultraviolet-induced isomerized chiral compound may be at least one of chiral compound materials such as chiral spiroene, chiral diarylethylene, and the like.

The liquid crystal composition in the liquid crystal layer may include a rigid polymer network structure, which can stabilize a plane-aligned state and a pitch of the cholesteric liquid crystals, thereby forming a plurality of areas of different pitches, that is, the reflective area, inside the liquid crystal layer.

In one embodiment, the polymerizable monomer in the liquid crystal composition can be heated to initiate a polymerization reaction of the polymerizable monomer to form a rigid polymer network structure, that is, a rigid polymer network structure.

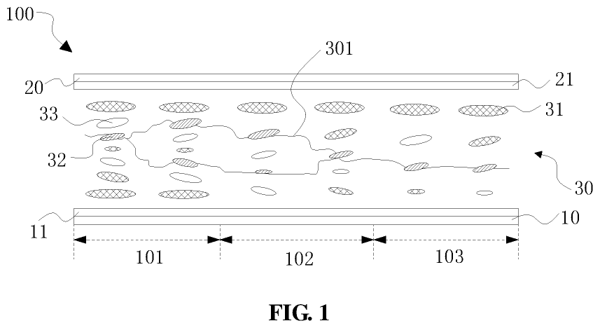

As shown in FIG. 1, in one embodiment, the reflective filter 100 includes a first reflective area 101, a second reflective area 102, and a third reflective area 103 that reflect light of three different colors, respectively.

A helical pitch of the cholesteric liquid crystals in the first reflective area 101, a helical pitch of the cholesteric liquid crystals in the second reflective area 102, and a helical pitch of the cholesteric liquid crystals in the third reflective area 103 increase in sequence, so that the liquid crystals in different reflective areas reflect light of different colors.

The liquid crystal composition includes nematic liquid crystals 31, a chiral compound 33, a polymerizable monomer 32, and a thermal initiator.

In one embodiment, each the first reflective area 101, the second reflective area 102, and the third reflective area 103 are configured to reflect one of red light, green light, and blue light, respectively.

For example, the first reflective area 101 is configured to reflect blue light, the second reflective area 102 is configured to reflect green light, and the third reflective area 103 is configured to reflect red light. The cholesteric liquid crystals that initially reflects blue light can be irradiated with ultraviolet light multiple times to realize a gradually red-shifted reflection band.

Specifically, the initial selective wavelength band of the cholesteric liquid crystals in the liquid crystal layer 30 may be set to correspond to blue light, the liquid crystal layer 30 corresponding to the first reflective area 101 is shielded, and the liquid crystal layer 30 corresponding to the other areas (the second reflective area 102 and the third reflective area 103) is irradiated with ultraviolet light once, so that the helical pitch of the cholesteric liquid crystals in the once-irradiation area is increased, and light in the reflection wavelength band corresponds to green light. After that, the liquid crystal layer 30 corresponding to the first reflective area 101 and the second reflective area 102 are shielded, and the third reflective area 103 is irradiated, so that the helical pitch of the cholesteric liquid crystals in the third reflective area 103 continues to increase, and the reflection band corresponds to red light. Then, the liquid crystal layer 30 is heated, causing the polymerizable monomer 32 to subject to a polymerization reaction to form the rigid polymer network structure 301.

Since the embodiments of the present application apply voltage to the first electrode 11 and the second electrode 21 to align the liquid crystal molecules, no additional alignment treatment is required for the inside of the first substrate 10 and the second substrate 20, and the manufacturing process is simple and costs can be saved.

Each of the first electrode 11 and the second electrode 21 may be provided over an entire surface. Since the reflective filter provided in an embodiment of the present application induces a chiral compound to subject to chiral inversion through ultraviolet light, the same kind of liquid crystal material matrix can be used to realize the division control of the reflective areas, there is no need to pattern the upper and lower electrodes, instead of, the electrode material is directly coated or deposited over an entire surface, and there is no need to set a retaining wall at a boundary of the partitions, which further simplifies the process.

The first electrode 11 and the second electrode 21 are transparent electrodes, which may be made of a material including indium tin oxide.

The first substrate 10 and the second substrate 20 may be flexible substrates or rigid substrates. The flexible substrate may be made of a material including polyimide, and the rigid substrate made of a material including a glass.

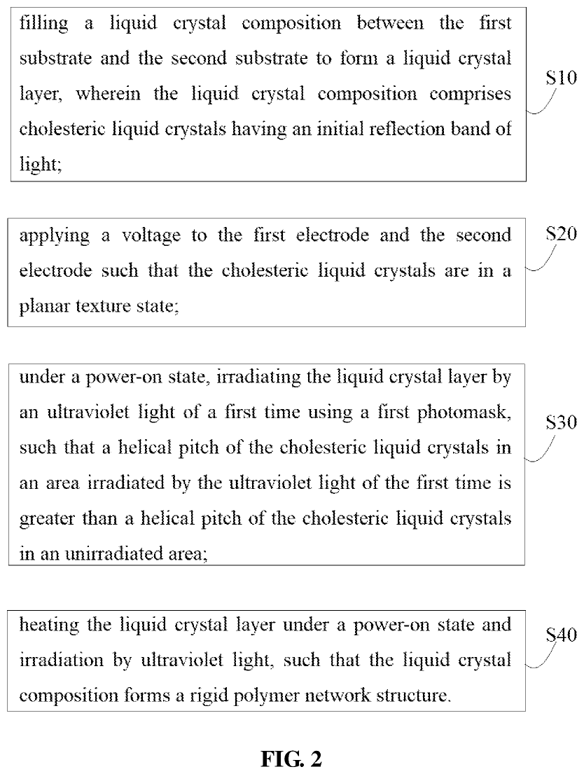

In view of the reflective filter provided in the above embodiments, another embodiment of the present application also provides a method of manufacturing the reflective filter, as shown in FIG. 2, including the following steps:

S10, filling a liquid crystal composition between the first substrate and the second substrate to form a liquid crystal layer, wherein the liquid crystal composition includes cholesteric liquid crystals having an initial reflection band of light.

In one embodiment, the cholesteric liquid crystals can be a mixture of nematic liquid crystals and a chiral compound, and the initial reflection wavelength of the cholesteric liquid crystals and light corresponding to the reflection wavelength can be controlled by changing the content of the chiral compound 33 in the liquid crystal composition.

The selection criteria for the content of the chiral compound can be based on making the initial reflection band of the cholesteric liquid crystals small, that is, selectin a small helical pitch, so that during subsequent irradiation with ultraviolet, the cholesteric liquid crystals in the irradiated area has a red-shifted reflection band and reflects light of a color different from the initial color.

S20, applying a voltage to the first electrode and the second electrode such that the cholesteric liquid crystals are in a planar texture state.

By applying an external electric field, the cholesteric liquid crystals and the polymerized monomer are in a planar texture state, thus completing the alignment of cholesteric liquid crystals.

S30, under a power-on state, irradiating the liquid crystal layer by an ultraviolet light of a first time using a first photomask, such that a helical pitch of the cholesteric liquid crystals in an area irradiated by the ultraviolet light of the first time is greater than a helical pitch of the cholesteric liquid crystals in an unirradiated area.

The first photomask includes a light-shielding area and a light-transmitting area. The liquid crystal layer corresponding to the light-transmitting area is irradiated with ultraviolet light, and the liquid crystal layer corresponding to the light-shielding area is not irradiated with ultraviolet light.

S40, heating the liquid crystal layer under a power-on state and irradiation by ultraviolet light, such that the liquid crystal composition forms a rigid polymer network structure.

During the heating process of the liquid crystal layer, the polymerizable monomer undergoes a polymerization reaction to form a rigid polymer to stabilize the planar texture state and the pitch of the cholesteric liquid crystals.

After the polymerization of the polymerizable monomer is completed, the voltage applied to the two electrodes is turned off, the irradiation by ultraviolet light is stopped, and the heating is stopped, so that the reflective filter described in any of the above embodiments can be obtained.

According to application situations of the filter, a number of reflective areas and a number of irradiation by ultraviolet light on different reflective areas can be set reasonably, so that the filter can reflect light of different colors.

For example, before the S40, the method may further includes: under a power-on state, irradiating the liquid crystal layer by ultraviolet light of a second time using a second mask, such that a helical pitch of the cholesteric liquid crystals in an area irradiated by ultraviolet light of the second time is greater than the helical pitch of the cholesteric liquid crystals in the area irradiated by ultraviolet light of the first time.

In one embodiment, the light in the initial reflection band corresponds to blue light, according to claim 9, wherein the light in the initial reflection band is blue light, the cholesteric liquid crystals in the area irradiated by the ultraviolet light of the first time are configured to reflect green light, and the cholesteric liquid crystals in the area irradiated by the ultraviolet light of the second time are configured to reflect red light.

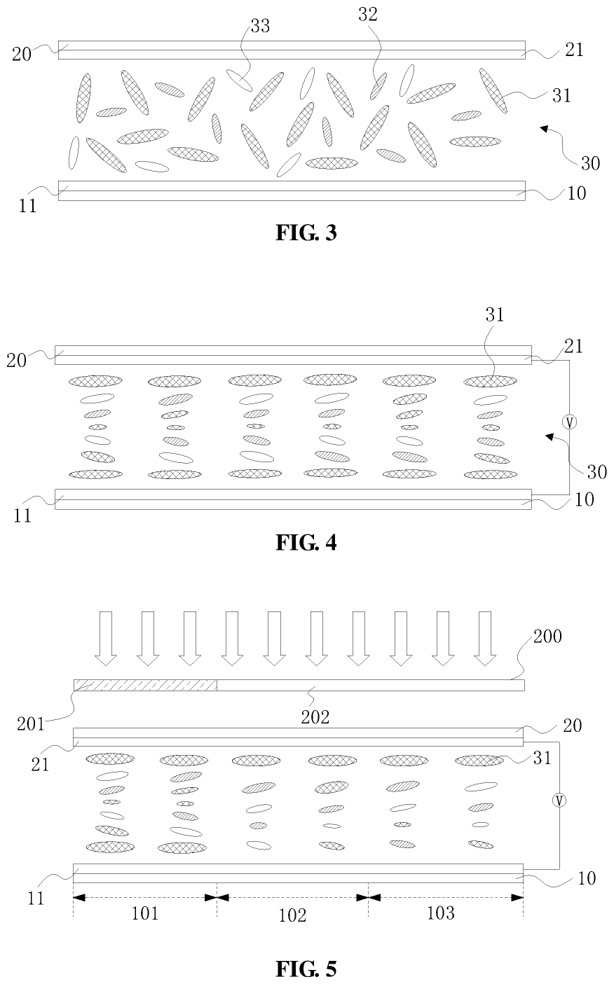

Referring to FIG. 3 to FIG. 6, in this embodiment, RGB color filters are taken as an example for description.

As shown in FIG. 3, first, the liquid crystal composition is poured into a liquid crystal cell, which refers to a space sandwiched between the first substrate 10 and the second substrate 20, and the initial selective wavelength band of cholesteric liquid crystals is set to correspond to blue light.

The liquid crystal composition can be filled by inkjet printing or pressed by a roll-to-roll process, specifically selected according to the substrate material.

The liquid crystal composition includes uniformly mixed negative nematic liquid crystals, ultraviolet-induced chiral-inversed compound, liquid crystal thermopolymerizable monomer, and thermal initiator.

Amounts in weight percentage of the negative nematic liquid crystals, the UV-induced chiral-inversed compounds, the liquid crystal thermopolymerizable monomers, and the thermal initiators is 60-98 wt % negative nematic liquid crystal, 1-30 wt % liquid crystal thermally polymerizable monomer, 0.05-10 wt % ultraviolet-induced isomerized chiral compound, and 0.05-2 wt % thermal initiator.

The ultraviolet-induced isomerized chiral compound has a first rotation direction (being left-handed or right-handed) under visible light, which can be inversed to have a second rotation direction (right-handed or left-handed) after being irradiated with ultraviolet light. The ultraviolet-induced isomerized chiral compound may be selected from one or more of chiral compound materials such as chiral spiroene, chiral diarylethylene, and the like.

The color reflected by the cholesteric liquid crystals is determined by the average refractive index of the liquid crystals (no is the refractive index of normal light and ne is the refractive index of abnormal light) and the helical pitch p of the chiral compound, and the helical pitch is determined by the content (χc) of the chiral compound and its own spiral twisting force (HTP), that is: λ=n*p, n=1/2 (no+ne), p=1/(HTP·χc).

In general, the average refractive index of the liquid crystals is 1.55-1.65. If requiring reflecting blue light (having a center wavelength of 440 nm), p may be set between 270-290 nm.

As shown in FIG. 4, a voltage V is applied to the first electrode 11 and the second electrode 21, and the cholesteric liquid crystals and the liquid crystal polymerizable monomer are in a planar texture state under the action of an electric field.

As shown in FIG. 5, under the power-on state, the liquid crystal layer 30 is irradiated by an ultraviolet light of a first time using a first photomask 200, such that a helical pitch of the cholesteric liquid crystals in an area irradiated by the ultraviolet light of the first time is greater than a helical pitch of the cholesteric liquid crystals in an unirradiated area, and light in the reflection wavelength band of the cholesteric liquid crystals in an area irradiated by the ultraviolet light of the first time corresponds to green light.

The first photomask 200 includes a light-shielding area 201 and a light-transmitting area 202, the light-shielding area 201 corresponds to the first reflective area 101, and the light-transmitting area 202 corresponds to the second reflective area 102 and the third reflective area 103, The first reflective area 101 is not irradiated with ultraviolet light and reflects blue light of the original wavelength band, while the second reflective area 102 and the third reflective area 103 are irradiated with ultraviolet light so that the helical pitch increases to reflect green light.

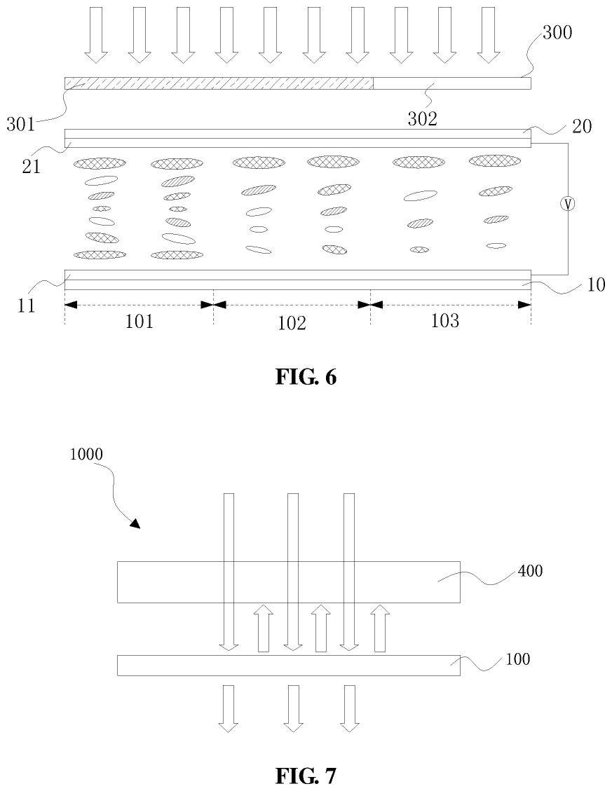

As shown in FIG. 6, after that, under a power-on state, the liquid crystal layer 30 is irradiated by ultraviolet light of a second time using a second photomask 300, such that a helical pitch of the cholesteric liquid crystals in an area irradiated by ultraviolet light of the second time is greater than the helical pitch of the cholesteric liquid crystals in the area irradiated by ultraviolet light of the first time, and thereby the area irradiated by ultraviolet light of the second time reflects red light.

Wherein, the second photomask 300 includes a light-shielding area 301 and a light-transmitting area 302, the light-shielding area 301 corresponds to the first reflecting area 101 and the second reflecting area 102, and the light-transmitting area 302 corresponds to the third reflecting area 103. Since the first reflective area 101 is never exposed to ultraviolet light, the initial reflection band is maintained and blue light is reflected. The second reflective area 102 is exposed to ultraviolet light only once and thus maintains the reflection band after irradiation by ultraviolet light, reflecting green light and third reflective area 103 is subjected to primary irradiation by ultraviolet light and secondary irradiation by ultraviolet light, so it maintains the reflection band after secondary irradiation by ultraviolet light and reflects red light.

As shown in FIG. 1, the liquid crystal layer 30 is heated under a power-on state and irradiation by ultraviolet light to initiate the polymerization reaction of the liquid-crystal thermopolymerizable monomer to form a rigid polymer to stabilize a planar texture state and pitch after irradiation by ultraviolet light of the cholesteric liquid crystals.

After the polymerization is completed, the electric field, UV-irradiation device and heating device are removed to obtain a reflective RGB color filter.

If the light in the initial reflection band of the cholesteric liquid crystals was blue light (having a center wavelength of 440 nm, and the amount of chiral compound was recorded as χcB), then when the cholesteric liquid crystals reflect green light (having a center wavelength of 550 nm) and red light (having a center wavelength of 700 nm), contents of the chiral compounds was 0.8χcB and 0.63χcB, respectively. Therefore, the amount of the chiral compound required to induce the chiral compound to subject to chiral inversion for the ultraviolet irradiation of the first time is 10%, and the amount of the chiral compound required to induce the chiral compound to subject to chiral inversion for the ultraviolet irradiation of the second time is 18.5%. The amount of ultraviolet light accumulated in the ultraviolet irradiation of the first time can be set to 3000-6000 mJ, and the amount of ultraviolet light accumulated in the ultraviolet irradiation of the second time can be set to 5550-11100 mJ.

The reflective filter in the above embodiments can be applied to the field of color display. As shown in FIG. 7, an embodiment of the present application further provides a reflective display device 1000 including a display panel 400 and a reflective filter 100 provided on a side away from a light-exiting surface of the display panel 400.

A structure and manufacturing method of the reflective filter 100 may be referred to the description of the foregoing embodiments, and details are not repeated herein for brevity.

When ambient light enters the reflective filter 100, the reflective area of the filter 100 reflects the light in a wavelength band corresponding to the cholesteric liquid crystals in the corresponding area, and the light of other colors passes through the reflective area, thereby realizing the filtering effect of the filter 100.

In the embodiments of the present application, on the one hand, on the one hand, by applying an external electric field to align the liquid crystal molecules, no additional liquid crystal alignment treatment is required, which makes the process simple and cost-effective; on the other hand, by using ultraviolet light to induce a chiral compound to subject to chiral inversion so as to realize partition control of the reflective are in the same liquid crystal material matrix, there is no need to pattern electrodes, the common electrode may be disposed over an entire surface, and no barrier wall is required, thereby further simplifying the process. In addition, the reflective color filter can be formed as a flexible film material due to addition of polymer materials, which is beneficial to realize a large-area roll-to-roll process, thereby reducing the production and transportation costs of the filter.

It can be understood that, for those of ordinary skill in the art, equivalent replacements or changes can be made according to the technical solutions and inventive concepts of the present application, and all such changes or replacements should fall within the protection scope of the claims appended to the present application.

1. A reflective filter, comprising:
a first substrate and a second substrate oppositely disposed, wherein a side of the first substrate facing the second substrate is provided with a first electrode, and a side of the second substrate facing the first substrate is provided with a second electrode; and
a liquid crystal layer interposed between the first substrate and the second substrate, wherein the liquid crystal layer is filled with a liquid crystal composition comprising cholesteric liquid crystal,
wherein the reflective filter comprises at least two reflective areas configured to reflect light of different colors, and the liquid crystal composition comprises a rigid polymer network structure continuously extending across the at least two reflective areas.

2. The reflective filter according to claim 1, further comprising a first reflective area, a second reflective area, and a third reflective area configured to respectively reflect light of three different colors.

3. The reflective filter according to claim 1, wherein a helical pitch of the cholesteric liquid crystals in the first reflective area, a helical pitch of the cholesteric liquid crystals in the second reflective area, and a helical pitch of the cholesteric liquid crystals in the third reflective area increase in sequence.

4. The reflective filter according to claim 2, wherein the first reflective area is configured to reflect blue light, the second reflective area is configured to reflect green light, and the third reflective area is configured to reflect red light.

5. (canceled)

6. The reflective filter according to claim 1, wherein the liquid crystal composition comprises a nematic liquid crystal, a chiral compound, a polymerizable monomer, and a thermal initiator.

7. The reflective filter according to claim 1, wherein each of the first electrode and the second electrode is disposed over an entire surface.

8. A method of manufacturing a reflective filter, comprising following steps:
S10, filling a liquid crystal composition between a first substrate and a second substrate to form a liquid crystal layer, wherein the liquid crystal composition comprises cholesteric liquid crystals having an initial reflection band of light;
S20, applying a voltage to a first electrode and a second electrode such that the cholesteric liquid crystals are in a planar texture state;
S30, under a power-on state, irradiating the liquid crystal layer by an ultraviolet light of a first time using a first photomask, such that a helical pitch of the cholesteric liquid crystals in an area irradiated by the ultraviolet light of the first time is greater than a helical pitch of the cholesteric liquid crystals in an unirradiated area, so as to form at least two reflective areas configured to reflect light of different colors;
S40, heating the liquid crystal layer under a power-on state and irradiation by ultraviolet light, such that the liquid crystal composition forms a rigid polymer network structure, wherein the rigid polymer network structure continuously extends across the at least two reflective areas.

9. The method of manufacturing the reflective filter according to claim 8, wherein before the step S40, the method further comprising:
under a power-on state, irradiating the liquid crystal layer by ultraviolet light of a second time using a second photomask, such that a helical pitch of the cholesteric liquid crystals in an area irradiated by ultraviolet light of the second time is greater than the helical pitch of the cholesteric liquid crystals in the area irradiated by ultraviolet light of the first time.

10. The method of manufacturing the reflective filter according to claim 9, wherein the light in the initial reflection band is blue light, the cholesteric liquid crystals in the area irradiated by the ultraviolet light of the first time are configured to reflect green light, and the cholesteric liquid crystals in the area irradiated by the ultraviolet light of the second time are configured to reflect red light.

11. The method of manufacturing the reflective filter according to claim 8, wherein the liquid crystal composition comprises a nematic liquid crystal, a chiral compound, a polymerizable monomer, and a thermal initiator.

12. A reflective display device, comprising a display panel and a reflective filter provided on a side away from a light-exiting surface of the display panel, wherein the reflective filter comprises:
a first substrate and a second substrate oppositely disposed, wherein a side of the first substrate facing the second substrate is provided with a first electrode, and a side of the second substrate facing the first substrate is provided with a second electrode; and
a liquid crystal layer interposed between the first substrate and the second substrate, wherein the liquid crystal layer is filled with a liquid crystal composition comprising cholesteric liquid crystal,
wherein the reflective filter comprises at least two reflective areas configured to reflect light of different colors, and the liquid crystal composition comprises a rigid polymer network structure continuously extending across the at least two reflective areas.

13. The reflective filter according to claim 12, wherein the reflective filter comprises a first reflective area, a second reflective area, and a third reflective area configured to respectively reflect light of three different colors.

14. The reflective filter according to claim 12, wherein a helical pitch of the cholesteric liquid crystals in the first reflective area, a helical pitch of the cholesteric liquid crystals in the second reflective area, and a helical pitch of the cholesteric liquid crystals in the third reflective area increase in sequence.

15. The reflective filter according to claim 13, wherein the first reflective area is configured to reflect blue light, the second reflective area is configured to reflect green light, and the third reflective area is configured to reflect red light.

16. (canceled)

17. The reflective filter according to claim 12, wherein the liquid crystal composition comprises a nematic liquid crystal, a chiral compound, a polymerizable monomer, and a thermal initiator.

18. The reflective filter according to claim 12, wherein each of the first electrode and the second electrode is disposed over an entire surface.
